(19) United States
(12) Patent Application Publication
(10) Pub. No.: US 2007/0218768 A1
(43) Pub. Date: Sep. 20, 2007

(54) Transflash-to-SD adaptive card structure

(76) Inventor: Yun-Hsiu Lee, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/378,330

(22) Filed: Mar. 20, 2006

(51) Int. Cl. H01R 24/00

(52) U.S. Cl. 439/630

(57) ABSTRACT

A transflash-to-SD adaptive card structure is composed of an upper housing, a lower housing, and an adaptive terminal module, to adapt a Transflash memory card into an SD memory card. The adaptive terminal module consists of a plurality of terminals and a moldbase for fixing positions of the terminals. The terminals are formed with 9 SD pins and 8 Transflash pins at a front end and a rear end of the moldbase, respectively. Above the SD pins of sixth and third terminals is installed with a bridge structure. Accordingly, after the adaptive terminal module is emplaced at a proper position between the upper and lower housings, the upper and lower housings are riveted and fixed by an ultrasonic wave, such that power ends of the bridge structure can be pressed down by the upper housing, thereby enabling the sixth terminal to be in contact with the third terminal for short-circuiting.

### BACKGROUND OF THE INVENTION

(a) Field of the Invention

The present invention relates to a Transflash-to-SD adaptive card structure, and more particularly to a bridge structure which is used for forming a short-circuiting between terminals in a Transflash-to-SD adaptive card, which will generate a contact short-circuit for two terminals that were originally not interconnected, so as to successfully transmit signals.

(b) Description of the Prior Art

As the popularity of 3C electronic consumer products, such as digital cameras, PDA (Personal Digital Assistant), and MP3 players, the development of flash memory cards becomes enriched as well, generating all kinds of memory cards with a variety of specifications. The most popular memory cards include SM (SmartMedia), xD-Picture Card, CF (CompactFlash), MD (MicroDrive), MS (Memory Stick), SD (Secure Digital), and MMC (MultiMedia Card). As the size of 3C digital products becomes smaller and smaller, memory cards with even smaller size are announced, including the Duo series extended from MS and MS PRO, miniSD and RS-MMC extended from SD and MMC, and the Transflash. In addition to the advantage in size and being without decreasing functions, Transflash is the smallest flash memory card in the world, having the size even smaller than a SIM (Subscriber Identity Module) card of current mobile phone, yet with the storage capacity much greater than that of the SIM card, and full compatibility with card reading devices used for the most popular SD memory cards in the market to quickly access data inside the memory cards, after being adapted through proper adaptive cards or adapters. Referring to FIG. 1 and FIG. 2, in manufacturing a Transflash-to-SD adaptive card a, a charge bridge b2 is first used to connect neighboring pins in an integrated terminal which is provided with 9 SD pins b1 and 8 Transflash pins c1, and the charge bridge b2 is removed when the terminal is fixed on a proper frame. As the number of pins and functions on an SD card b and a Transflash card c are all different, a short-circuit should be performed on a third pin and a sixth pin on the SD pins b1 in manufacturing. However, due to a limited inner space between an upper casing and a lower casing, a proper bridge structure should be used to proceed with the short-circuiting. Referring to FIG. 3, the present inventor has disclosed a structure of integrated terminal in the drawings of Taiwan Utility Patent M265796, “Transflash Adaptive Card Structure,” wherein a connection member b3 for bridge short-circuiting is installed on a third pin and a sixth pin of the SD pins b1. The connection member b3 proceeds with the connecting through a flanging to front ends of the third pin and the sixth pin. It is shown from the drawing that there is a difference in height (x=0.3 mm) between the front ends of the third pin and the sixth pin. Therefore, a stress for warping will exist on the connection member b3 after bending. Accordingly, a thinner and elastic part should be included in the design of connection member b3, which is difficult to manufacture and the connection member b3 will be damaged in assembling to affect a normal usage of adaptive card, due to a non-uniform force of installation and a roughness of surface; therefore, an improvement is required.

Accordingly, a brand new Transflash-to-SD adaptive card structure is designed, wherein a proper bridge structure is extended from a front end of the sixth SD pin to touch with the third SD pin for short-circuiting. When the bridge structure is not assembled, it is separated with the third pin to form a non-contact status. Therefore, there will be no any residual stress in manufacturing, for facilitating electroplating. In addition, upon assembling, the bridge structure will be automatically pressed down by the upper housing to enable the sixth SD pin to be in contact with the third SD pin for short-circuiting.

### SUMMARY OF THE INVENTION

The primary object of the present invention is to provide a Transflash-to-SD adaptive card to serve as a bridge structure for short-circuiting between terminals, which is convenient for assembling personnel to proceed with the assembling, and is rather simple in manufacturing and processing.

Accordingly, the present invention comprises an upper housing, a lower housing, and an adaptive terminal module. The adaptive terminal module is composed of a plurality of terminals and a moldbase for fixing the positions of terminals, wherein the terminals are formed with 9 SD pins and 8 Transflash pins at a front end and a rear end of the moldbase, respectively. Except that a third terminal is an independent SD pin, the rest are long terminals extending from the SD pins to the Transflash pins. Above the SD pins of a sixth and a third terminals is installed with a bridge structure which is a spring leaf with one end being connected to a front end of the sixth SD pin, and a power end at the other end being located above the third terminal, or a bend piece being installed in an inner surface of upper housing, with two power ends being located above the sixth and third SD pins, respectively. The aforementioned bridge structure enables a contact short-circuiting to be formed at the sixth and third SD pins, after assembling the upper and lower housings.

Upon assembling according to the aforementioned structures, the adaptive terminal module after being processed with the Insert Molding method is directly emplaced at a proper position between the upper and lower housings, then the upper and lower housings are riveted and fixed with an ultrasonic wave, and the SD pins and the Transflash pins of the adaptive terminal module reach to fixed positions of adaptive card, respectively. The power ends of bridge structure on the adaptive terminal module enables the sixth terminal to be in contact with the third terminal to achieve a short-circuit, by a press-down force when covering with the upper housing, which can facilitate assembling personnel to proceed with assembling. The bridge structure itself is an independent structure, therefore it will not generate residual stress in manufacturing and it will manifest a separation configuration when it is not assembled. In addition, it can also facilitate electroplating to the whole terminal, which enables a rather simple manufacturing and processing.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of relative position of terminals of a conventional SD card and a Transflash card.

FIG. 2 shows a schematic view of a conventional adaptive terminal for an SD card and a Transflash card.

FIG. 3 shows a schematic view of structure of a conventional adaptive terminal.

FIG. 4 shows an exploded view of the present invention.

FIG. 5 shows an exploded view of another embodiment of the present invention.

FIG. 6 shows a cutaway view of FIG. 4.

FIG. 7 shows a cutaway view of FIG. 5.

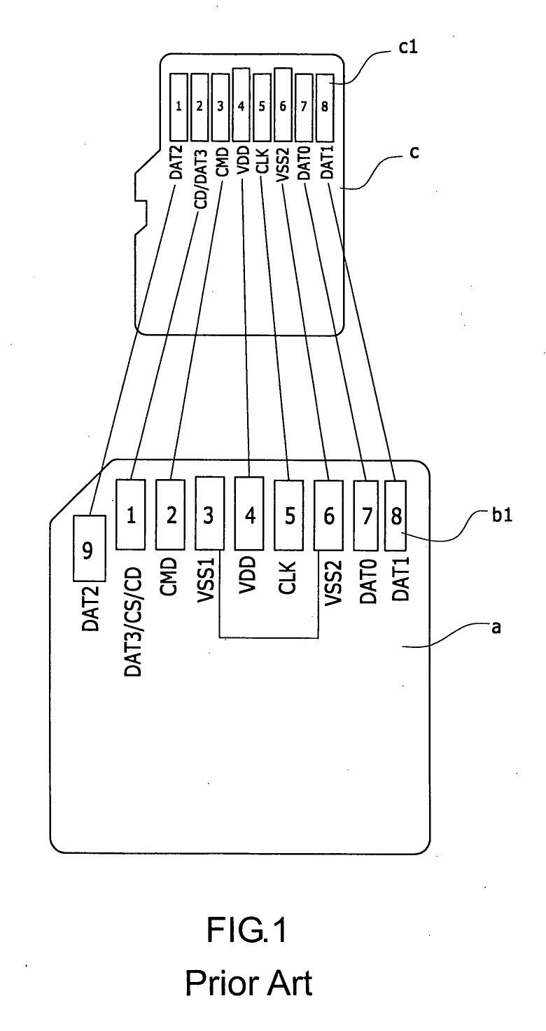

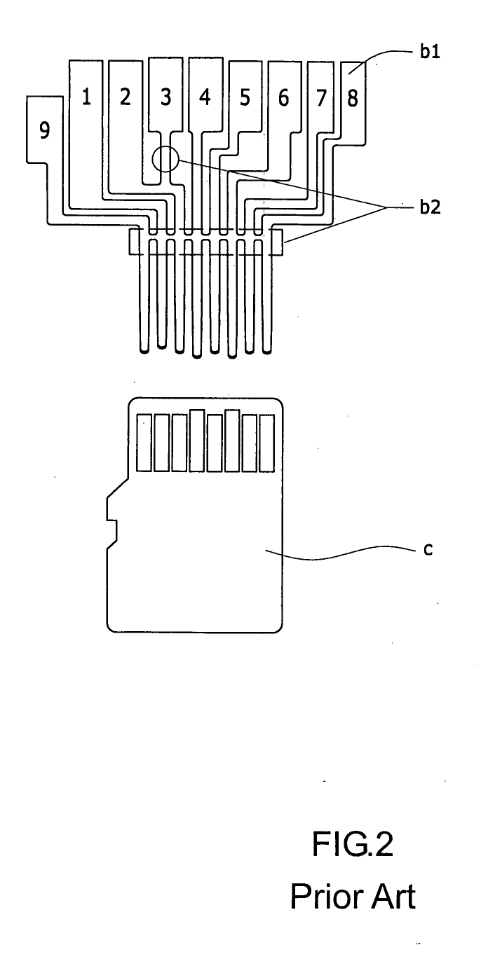

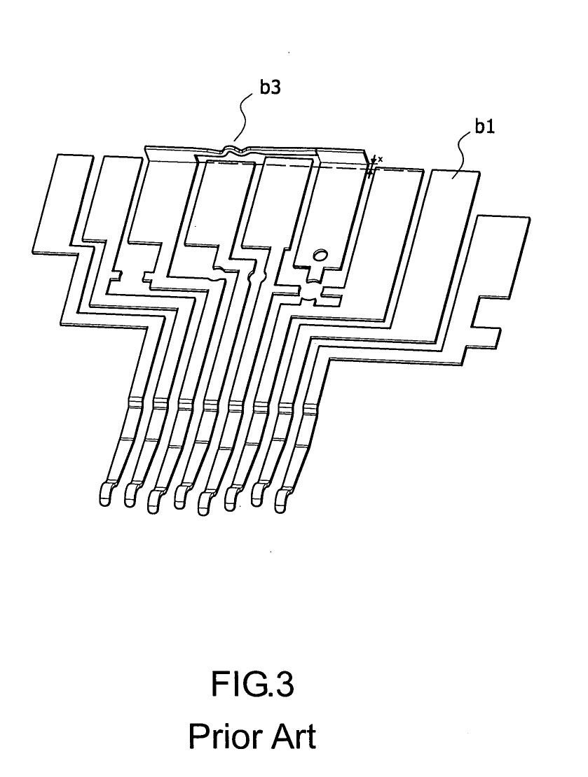

### DETAILED DESCRIPTION OF THE PREFERRED EMBODIMENTS

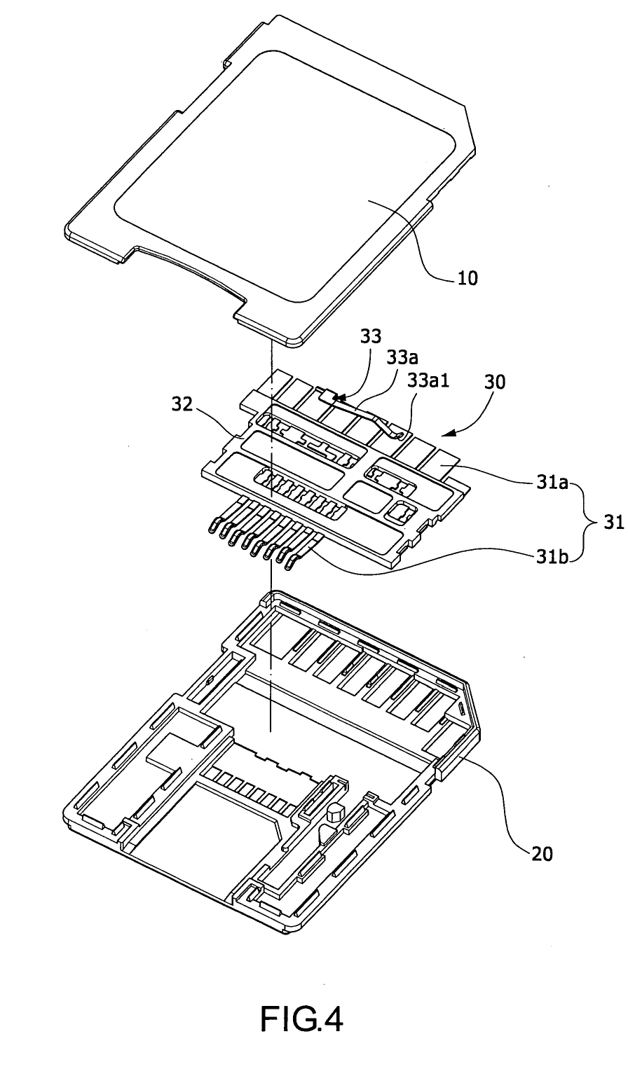

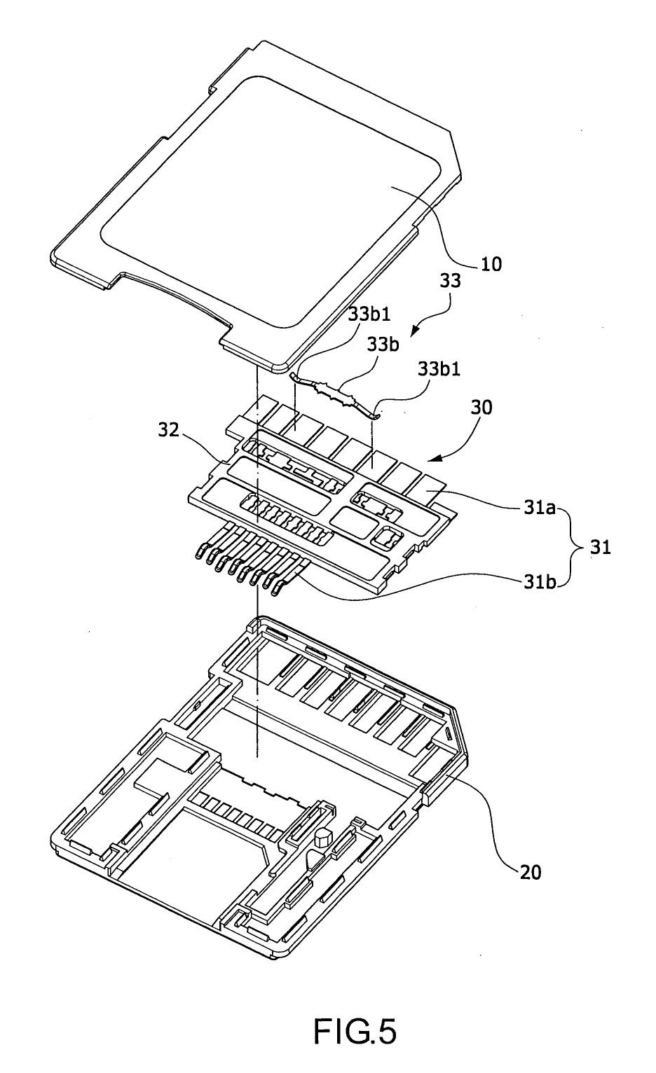

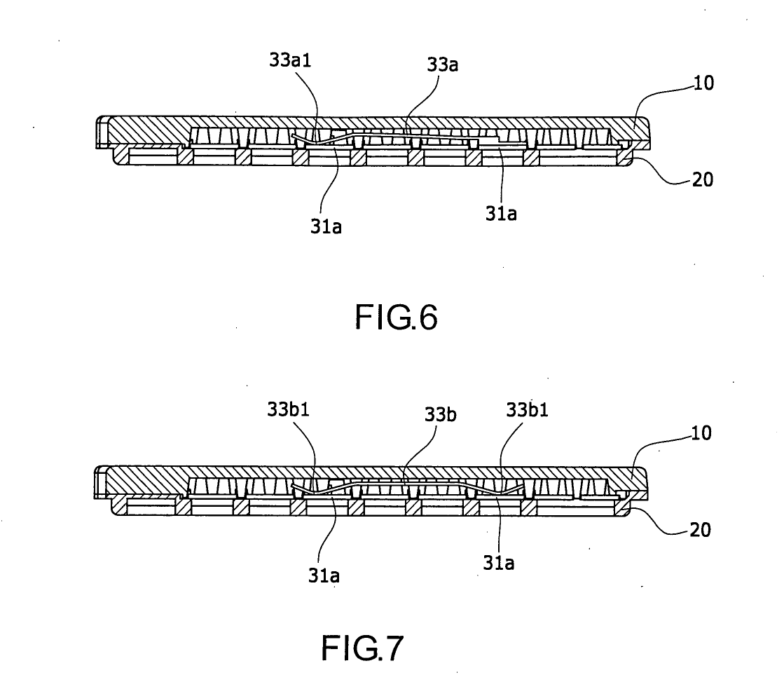

Referring to FIGS. 4 to 7, the present invention comprises an upper housing 10, a lower housing 20, and an adaptive terminal module 30, for adapting a Transflash memory card into an SD memory card. The adaptive terminal module 30 is composed of a plurality of terminals 31 and a moldbase 32 for fixing positions of the terminals 31, wherein the terminals 31 are formed with 9 SD pins 31a and 8 Transflash pins 31b at a front end and a rear end of the moldbase 32, respectively. Except that a third terminal is an independent SD pin 31a, the rest are long terminals 31 extending from the SD pins 31a to the Transflash pins 31b. Above the SD pins 31a of a sixth and a third terminals is installed with a bridge structure 33 which is a spring leaf 33a with one end being connected to a front end of the sixth SD pin 31a, and a power end 33a1 of the other end being located above the third terminal 31, or a bend piece 33b installed in an inner surface of the upper housing 10 with two power ends 33b1 of the bend piece 33b being located above the sixth and third SD pins 31a, respectively. The aforementioned bridge structure 30 enables the sixth and third SD pins 31a to form into a contact short-circuit, after assembling the upper and lower housings 10, 20.

Upon assembling, the adaptive terminal module 30 is directly emplaced at a proper position between the upper and lower housings 10, 20, then the upper and lower housings 10, 20 are riveted and fixed with an ultrasonic wave, and the SD pins 31a and the Transflash pins 31b of the adaptive terminal module 30 reach to fixed positions of adaptive card, respectively. Next, the power ends 33a1, 33b1 of bridge structure 33 of the adaptive terminal module 30 enables the sixth SD pin 31a to be in contact with the third SD pin 31a to achieve a short-circuit, by a press-down force when covering with the upper housing 10.

Accordingly, the present invention serves as a bridge structure for performing a contact short-circuiting, which facilitates an assembling work, and is rather simple in manufacturing and processing.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A transflash-to-SD adaptive card structure including an upper housing, a lower housing, and an adaptive terminal module, to adapt a transflash memory card into an SD memory card, wherein the adaptive terminal module consists of a plurality of terminals and a moldbase for fixing positions of the terminals; the characteristics of adaptive card structure being that the terminals are formed with 9 SD pins and 8 transflash pins at a front end and a rear end of the moldbase respectively; wherein a third terminal is an independent SD pin, the remaining terminals are all long terminals extending from the SD pins to the transflash pins; wherein above the SD pins of sixth and third terminals a bridge structure is installed; and wherein, upon assembling, the adaptive terminal module is emplaced at a proper position between the upper and lower housings, followed by riveting and fixing the upper and lower housings, such that at least one power end of the bridge structure is both pressed down and held in contact with the third terminal by the upper housing to be in contact with both the third terminal and sixth terminal to achieve a short-circuit.

2. The transflash-to-SD adaptive card structure according to claim 1, wherein the bridge structure is a spring leaf, another end of which is connected to a front end of the sixth SD pin, and the at least one power end is located above the third terminal.

3. The transflash-to-SD adaptive card according to claim 1, wherein the bridge structure is a separate bend piece which is installed in an inner surface of the upper housing with another power end of the bend piece being located above the sixth SD pins and the at least one power end of the bend piece being located above the third SD pin.
